(19) United States
(12) Patent Application Publication
(10) Pub. No.: US 2012/0168253 A1
(43) Pub. Date: Jul. 5, 2012

(54) Ladder stabilizer

(76) Inventor: Daniel McMurray, St-Paul-de-l'lle-aux-Noix (CA)

(21) Appl. No.: 13/373,057

(22) Filed: Nov. 3, 2011

Related U.S. Application Data
(63) Continuation-in-part of application No. 12/221,834, filed on Aug. 7, 2008, now abandoned.

(51) Int. Cl. E06C 7/10

(52) U.S. Cl. 182/172

(57) ABSTRACT

A ladder stabilizer for use with a ladder having a pair of side rails with rungs extending therebetween, the ladder stabilizer comprising first and second rear legs designed to extend rearwardly of the ladder, first and second lateral legs designed to extend laterally of the ladder, the first and second rear legs being interconnected with each other, the first and second rear legs also being connected to a respective side rail of the ladder, with flexible cables extending between the lateral legs and the first interconnecting member.

The present application is a continuation-in-part of application Ser. No. 12/221,834 filed Aug. 7, 2008.

### FIELD OF THE INVENTION

The present invention relates to a ladder stabilizer.

### BACKGROUND OF THE INVENTION

The use of elongated ladders to reach elevated work areas is well known in the art. The ladders are used by people varying from professional workmen to home owners or do-it-yourselfers. Inherently, the use of such ladders carries a high degree of risk and each year many users are severely injured or even killed due to falls from the ladder.

It is well known that ladders are susceptible to lateral slippage when in use due to the narrow base of the ladders. The slippage can occur due to an unbalanced lateral distribution of the weight of the user on the ladder or of equipment or supplies supported on the ladder. The problem is particularly prevalent when the upper end of the ladder rests against a smooth surface which does not provide sufficient frictional resistance to sliding of the ladder end therealong.

The same problem can arise at the other end of the ladder in that the work areas can also provide only a minimal frictional engagement and as a result, the ladders can be susceptible to sliding out from under the user.

Still further, the work areas in which the ladders are utilized frequently do not provide a substantially flat surface on which to rest the lower end of the ladder. Positioning of the ladders on irregular or uneven surfaces can result in slippage of the ladder.

A still further problem which can occur is that the surface upon which the upper portion of the ladder should rest might not be suitable in the sense that they are frequently of fragile material such as glass or aluminum.

### SUMMARY OF THE INVENTION

It is an object of the present invention to provide a ladder stabilizer which overcomes the above disadvantages.

According to one aspect of the present invention, there is provided a ladder stabilizer for a ladder having a pair of side rails with rungs extending therebetween comprising first and second rear legs each having a distal end and a proximal end, the proximal ends being designed to be secured to a respective side rail of the ladder at a point spaced from an end of the respective side rail by a distance equal to between 25% and 75% of the side rail length, a first interconnecting member extending between the first and second rear legs intermediate their respective distal and proximal ends, a second interconnecting member having a first end connected to the first rear leg intermediate the distal and proximal ends thereof with a second end thereof designed to be secured at a side rail of the ladder, a third interconnecting member having a first end connected to the second rear leg intermediate the distal and proximal ends and a second end thereof designed to be secured to a side rail of the ladder, first and second lateral legs each having a distal end and a proximal end, the proximal ends being designed to be secured to a respective rear leg at the proximal end thereof, a first flexible cable extending between the first lateral leg and the second interconnecting member; and a second cable extending between the second lateral leg and the third interconnecting member.

According to a further aspect of the present invention, there is provided a ladder and a stabilizer for the ladder, the ladder comprising first and second side rails and a plurality of rungs extending between the side rails, the ladder stabilizer comprising first and second rear legs each having a distal end and a proximal end, the proximal end of the first rear leg being secured to the first side rail of the ladder at a point spaced from an end of the first side rail by a distance equal to between 25% and 75% of the first side rail length, the proximal end of the second rear leg being secured to the second side rail of the ladder at a point same as above, a first interconnecting member extending between the first and second rear legs intermediate their respective distal and proximal ends, a second interconnecting member having a first end connected to the first rear leg intermediate the distal and proximal ends thereof, with a second end thereof secured to the first side rail of the ladder, a third interconnecting member having a first end connected to the second rear leg intermediate the distal and proximal ends thereof, and a second end thereof secured to the second side rail of the ladder, a first lateral leg having a distal end and a proximal end, the proximal end being secured to the proximal end of the first rear leg, a second lateral leg having a distal end and a proximal end, the proximal end thereof being secured to the proximal end of the second rear leg, a first flexible cable extending between the first lateral leg and the second interconnecting member and a second cable extending between the second lateral leg and the third interconnecting member.

The ladder stabilizer of the present invention may be used either with a conventional ladder having a pair of side rails with rungs extending therebetween or extension ladders which comprise two ladder portions. The ladders may be either metallic or a reinforced fibreglass or plastic material. Preferably, each of the legs of the stabilizer are telescopic in nature so as to be adjustable for different circumstances and terrain. The structure of telescoping legs is well known in the art and any suitable arrangement may be utilized.

### BRIEF DESCRIPTION OF THE DRAWINGS

Having thus generally described the invention, reference will be made to the accompanying drawings illustrating an embodiment thereof, in which:

FIG. 1 is a perspective view of a stabilizer apparatus according to one embodiment of the present invention;

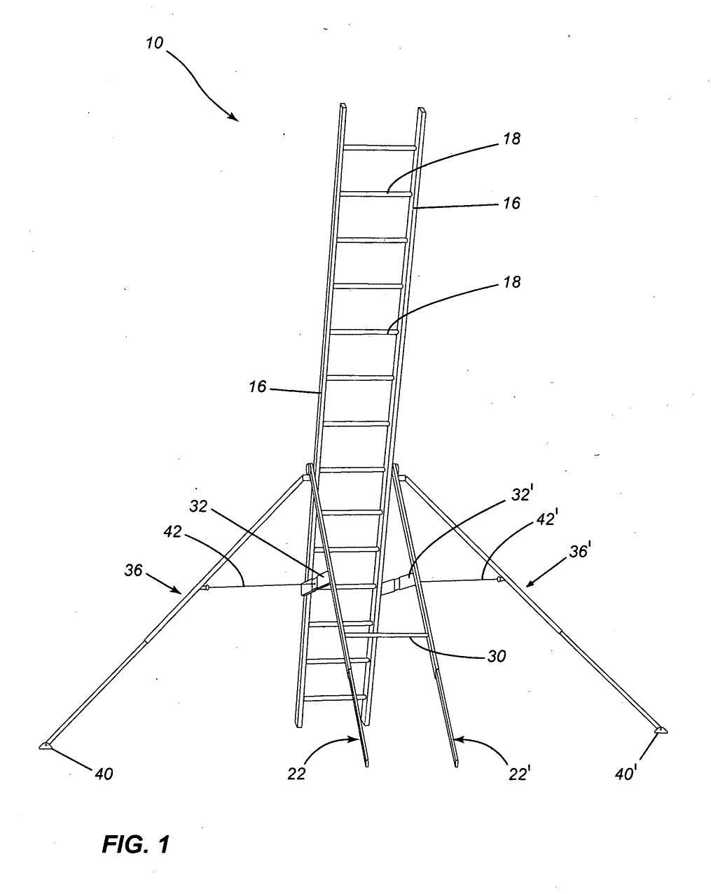

FIG. 2 is a side elevational view thereof; and

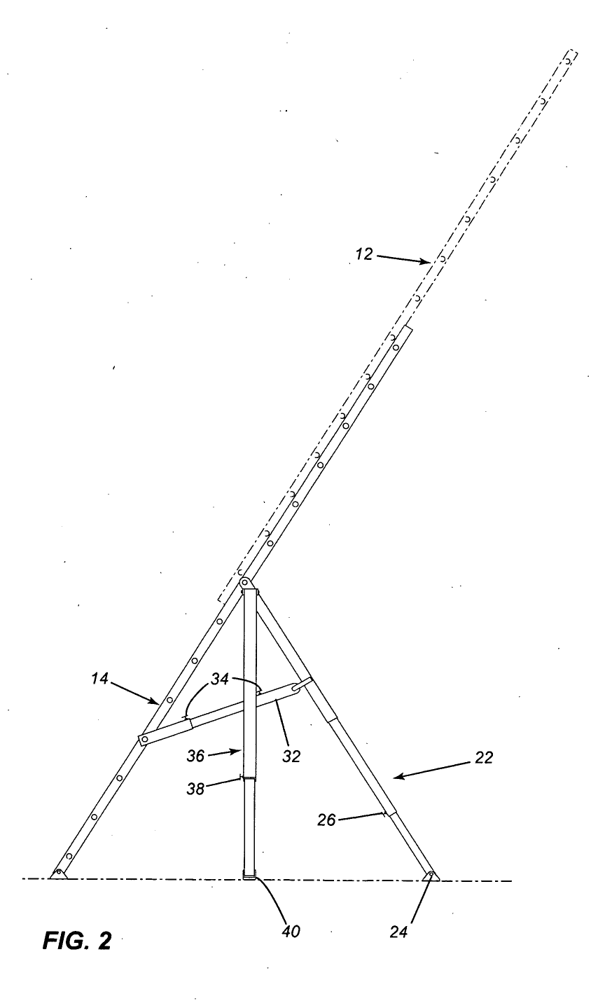

FIGS. 3A to 3D illustrate the set up of the ladder stabilizer apparatus.

### DETAILED DESCRIPTION OF THE INVENTION

Referring to the drawings in greater detail, and by reference characters thereto, there is illustrated an extension ladder which is generally designated by reference numeral 10.

Extension ladder 10 is of a substantially conventional design and includes an upper section 12 and a lower section 14 which are in slidable engagement with each other. Each of upper and lower sections 12, 14 includes a pair of longitudinal stiles or side rails 16 and a plurality of horizontal rungs 18 extending therebetween. Again, this is a conventional structure known in the art.

The stabilizer assembly of the present invention includes a pair of rear stabilizer legs 22, 22′. As both legs are substantially identical, only one will be described herein.

Rear stabilizing leg 22 has 2 or more segments which are telescopic in nature to permit adjustment for any type of terrain. To this end, there is provided one or more locking members 26 for securing the segments in a locked position. A pawl 28 is located at the outer most end of rear stabilizer leg 22.

Rear stabilizing legs 22, 22′ are connected by an interconnecting member 30. At their proximal end, rear stabilizing legs 22, 22′ are connected to the stiles 16 of lower section 14. Although many different types of connections may be utilized, a preferred one utilizes a member extending through one of the rungs 18. First rear stabilizing legs 22, 22′ are connected to lower section 14 at a distance of between 25% and 75% and more preferably between 35% and 65% of the total length of lower section 14. In other words, in the case of a 16 foot lower section, they are connected at a point between 4 and 12 feet from the ends of stiles 16. The connection point will depend on the desired angle for use of the ladder.

Extending between rear legs 22, 22′ and respective stiles 16 are side connectors 32, 32′ respectively. Again, side connectors 32, 32′ are telescopic in nature and include locking members 34 to secure the same at a desired length.

The stabilizer assembly also includes a pair of lateral legs 36, 36′ again, each being substantially identical. Lateral leg 36, as may be seen, includes a locking member 38 for locking the telescoping sections together. At the end of each lateral legs 36, 36′ there is provided a pawl 40, 40′. It will also be noted that there are provided cables 42, 42′ extending between their respective lateral legs and interconnecting with side connectors 32, 32′.

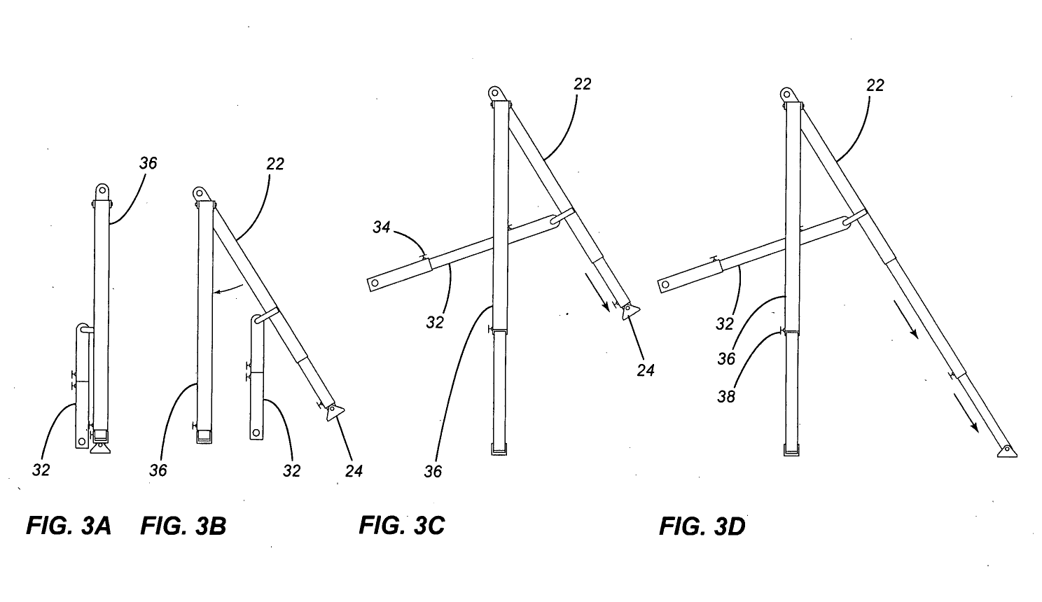

The stabilizer assembly is a compact one as shown in FIGS. 3A to 3D. It is shown in its stored position in FIG. 3A. As may be seen in FIG. 3B, rear leg 22 is pivoted outwardly and extended to its desired length as shown in FIGS. 3C and 3D. Similarly, lateral leg 36 is pivoted outwardly and set to a desired length. Finally, side connector 32 is secured to the stiles 16 as is rear stabilizer leg 22.

It will be understood that the above described embodiment is for purposes of illustration only and that changes and modifications may be made thereto without departing from the spirit and scope of the invention.

I claim:

1. A ladder stabilizer for a ladder having a pair of side rails with rungs extending therebetween comprising:
first and second rear legs each having a distal end and a proximal end, said proximal ends being designed to be secured to a respective side rail of the ladder at a point spaced from an end of the respective side rail by a distance equal to between 25% and 75% of the side rail length;
a first interconnecting member extending between said first and second rear legs intermediate their respective distal and proximal ends;
a second interconnecting member having a first end connected to said first rear leg intermediate said distal and proximal ends thereof with a second end thereof designed to be secured at a side rail of the ladder;
a third interconnecting member having a first end connected to said second rear leg intermediate said distal and proximal ends and a second end thereof designed to be secured to a side rail of the ladder;
first and second lateral legs each having a distal end and a proximal end, said proximal ends being designed to be secured to a respective rear leg at the proximal end thereof;
a first flexible cable extending between said first lateral leg and said second interconnecting member; and a second cable extending between said second lateral leg and said third interconnecting member.

2. The ladder stabilizer of claim 1 wherein said first and second rear legs each have a telescoping structure.

3. The ladder stabilizer of claim 2 wherein said distal ends of said first and second rear legs each have a foot pad.

4. The ladder stabilizer of claim 2 wherein each of said first and second lateral legs have a telescoping structure.

5. The ladder stabilizer of claim 4 wherein said second interconnecting member and said third interconnecting member each have a telescoping structure.

6. A ladder and a stabilizer for the ladder, the ladder comprising first and second side rails and a plurality of rungs extending between said side rails, said ladder stabilizer comprising:
first and second rear legs each having a distal end and a proximal end, said proximal end of said first rear leg being secured to said first side rail of said ladder at a point spaced from an end of said first side rail by a distance equal to between 25% and 75% of the first side rail length, said proximal end of said second rear leg being secured to said second side rail of said ladder at a point same as above;
a first interconnecting member extending between said first and second rear legs intermediate their respective distal and proximal ends;
a second interconnecting member having a first end connected to said first rear leg intermediate said distal and proximal ends thereof, with a second end thereof secured to said first side rail of said ladder;
a third interconnecting member having a first end connected to said second rear leg intermediate said distal and proximal ends thereof, and a second end thereof secured to said second side rail of said ladder;
a first lateral leg having a distal end and a proximal end, said proximal end being secured to said proximal end of said first rear leg;
a second lateral leg having a distal end and a proximal end, said proximal end thereof being secured to said proximal end of said second rear leg;
a first flexible cable extending between said first lateral leg and said second interconnecting member; and
a second cable extending between said second lateral leg and said third interconnecting member.

7. The ladder and stabilizer of claim 6 wherein said first and second rear legs each have a telescoping structure.

8. The ladder and stabilizer of claim 7 wherein said distal ends of said first and second rear legs each have a foot pad.

9. The ladder and stabilizer of claim 7 wherein each of said first and second lateral legs have a telescoping structure.

10. The ladder and stabilizer of claim 9 wherein said second interconnecting member and said third interconnecting member each have a telescoping structure.
